(19) United States
(12) Patent Application Publication
(10) Pub. No.: US 2014/0351143 A1
(43) Pub. Date: Nov. 27, 2014

(54) METHOD AND SYSTEM FOR SECURING A PAYMENT CARRIED OUT WITH THE AID OF A PAYMENT CARD

(71) Applicant: PW GROUP, Paris (FR)

(72) Inventor: Patrick Wajsbrot, Paris (FR)

(21) Appl. No.: 14/368,378

(22) PCT Filed: Dec. 21, 2012
(86) PCT No.: PCT/EP2012/076658

§ 371 Date: Jun. 24, 2014

(30) Foreign Application Priority Data
Dec. 30, 2011 (FR) 1162584

(51) Int. Cl. G06Q 20/40; G06Q 20/34

(52) U.S. Cl. CPC G06Q 20/401; G06Q 20/34
USPC 705/64

(57) ABSTRACT

This method for securing a payment carried out with the aid of a payment card associated with card identification data and a security cryptogram, is characterized in that it includes a step (2) for accessing means (1) forming a bank server for the dynamic generation of the security cryptogram for securing the payment.

The present invention relates to a method and a system for securing a payment carried out with the aid of a payment card.

Such a payment today is for example done by inserting a certain number of pieces of information into the payment service, such as the card number, the final validity date or expiration date thereof, and a security cryptogram.

This information is for example distributed on each surface of the card, which makes it possible to improve the security of this payment, since it is then very difficult to access all of the information required to validate a payment, for example a fraudulent payment.

Thus, for example, certain pieces of information, such as the card number and expiration date, may be on one surface of the card, while the cryptogram is on the other surface thereof.

However, it is not completely impossible to recover all of these pieces of information, which results in general security problems for this type of payment.

The aim of the invention is therefore to resolve these problems.

To that end, the invention relates to a method for securing a payment carried out with the aid of a payment card associated with card identification data and a security cryptogram, characterized in that it includes a step for accessing means forming a bank server for the dynamic generation of the security cryptogram for securing the payment.

The method according to the invention may comprise one or more of the following features, considered alone or according to any technically possible combination(s):
it includes a step for accessing the bank server-forming means to activate the card;
the generation/activation is triggered at the user's initiative;
the access step includes:
   a step for the insertion of identification data by the user,
   a step for voice connection between the user and the server-forming means, and
   a step for voice authentication of the user to validate, or not validate, access to the server-forming means, by the latter;
the step for insertion by the user of identification data comprises a step for the introduction by the latter of a connection code;
the connection code has been provided to the user by the server-forming means, during the registration of that user in the server-forming means;
the step for creating a voice connection between the user and the server-forming means includes a step for calling the identified user at a preregistered telephone number;
the voice authentication step includes determining the user's voice print in order to authenticate, or not authenticate, that user;
the voice authentication step includes the acquisition, by the server-forming means, of pre-established messages dictated by the user and comparing those acquired messages to messages pre-recorded in the server-forming means by the user, to authenticate, or not authenticate, that user.

According to another aspect, the invention also relates to a system for implementing such a method.

The invention will be better understood using the following description, provided solely as an example and done in reference to the appended drawings, in which:

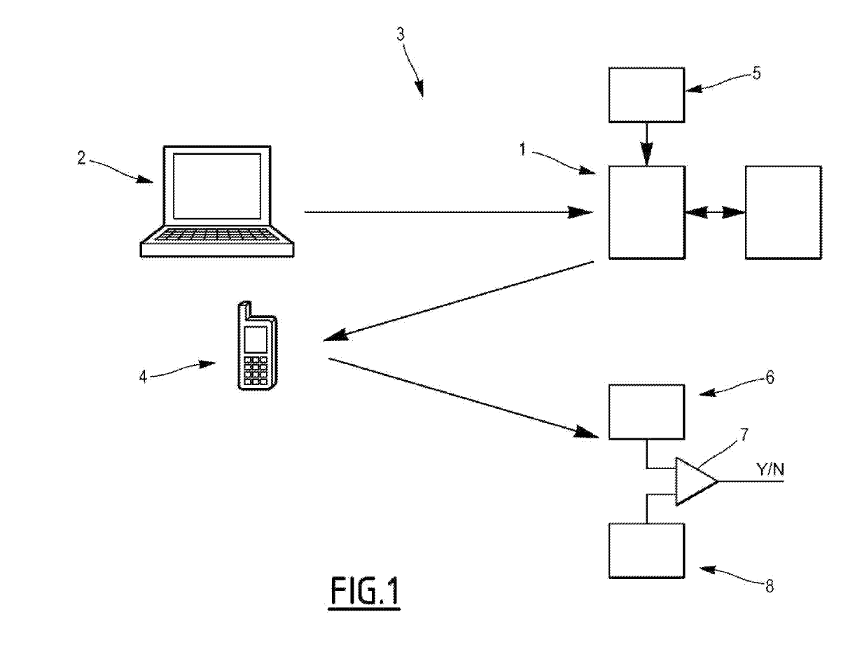

FIG. 1 shows a block diagram illustrating the structure and operation of a method and an access system for accessing bank server-forming means,

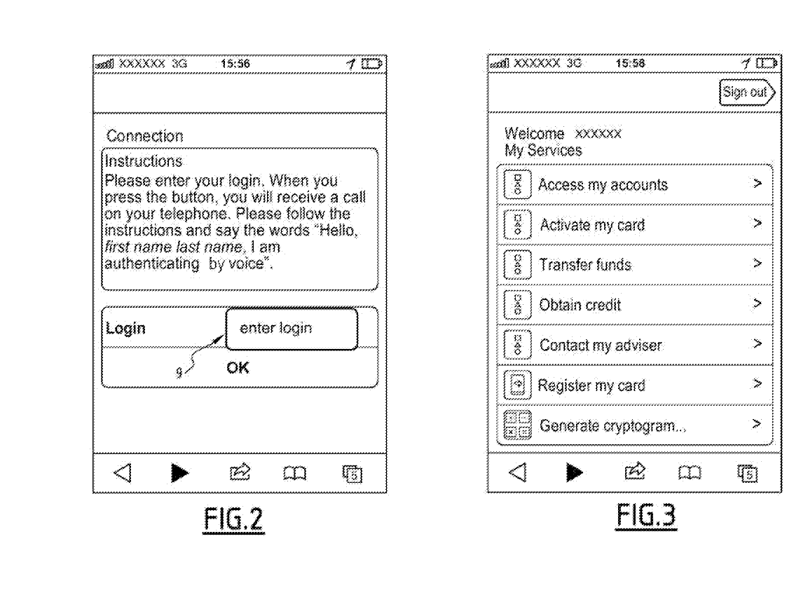

FIGS. 2 and 3 show graphic interfaces illustrating the access to these bank server-forming means,

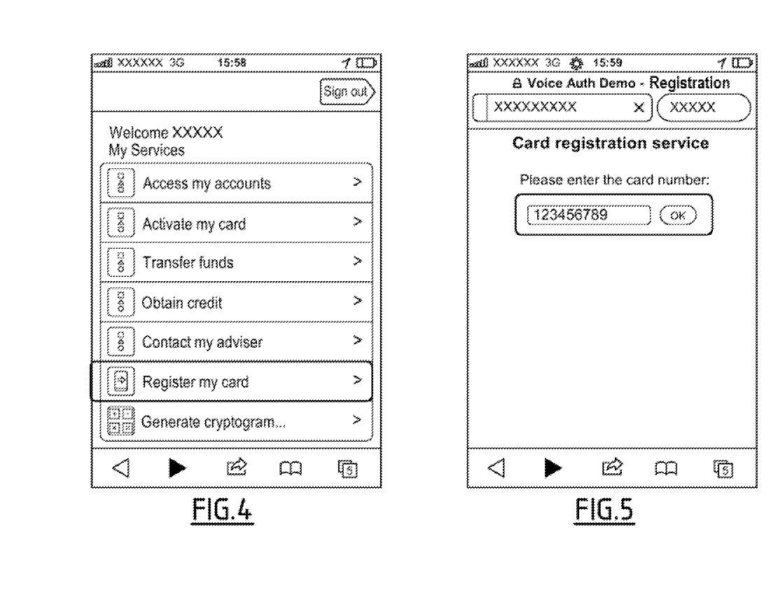

FIGS. 4 and 5 show graphic interfaces illustrating the registration of a bank card with these bank server-forming means,

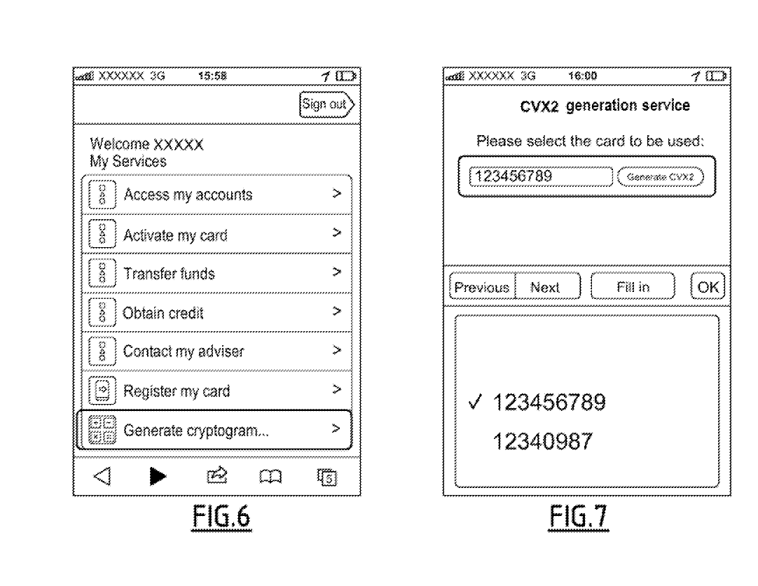

FIGS. 6 to 9 illustrate the dynamic generation and the use of a security cryptogram for payment with the aid of a bank card, and

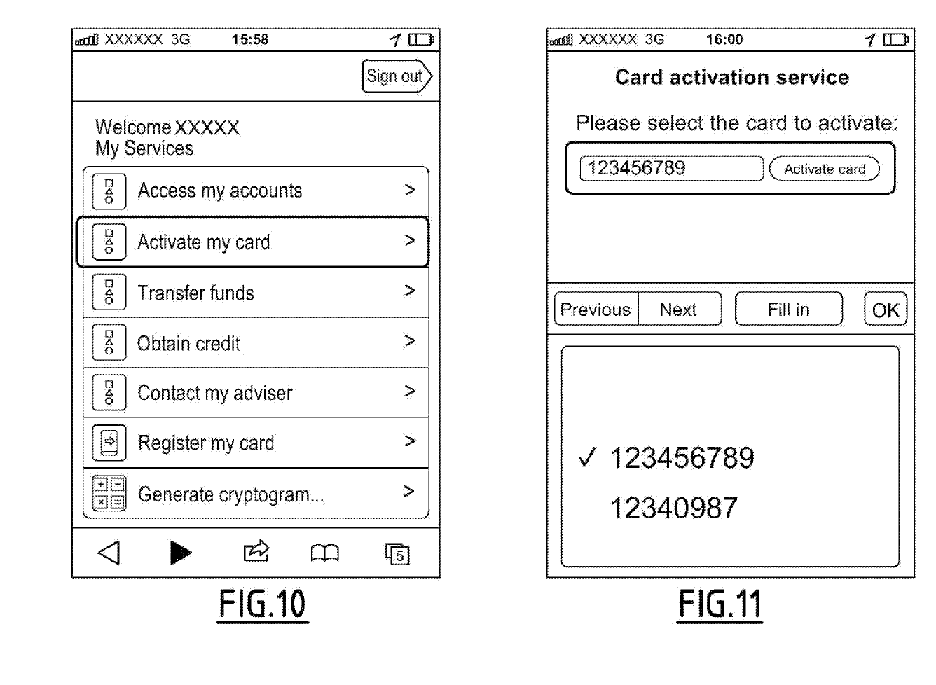

FIGS. 10 to 12 show graphic interfaces illustrating the activation of a bank card with these bank server-forming means.

These figures illustrate a method and a system for controlling the access by a user to means forming a server, in particular a bank server.

This access is for example done using computerized, telephone or other means at the user's disposal.

In FIG. 1, the bank server-forming means are designated by general reference 1, while the user has a tool such as a computer, provided with means for introducing identification data into the server-forming means, at his disposal.

Thus, for example, this computer is designated by general reference 2 in FIG. 1, and is for example connected through an information transmission network, for example 3, to the server-forming means 1.

The user also for example has a telephone, such as a mobile telephone, designated by general reference 4.

In fact, in the method and system according to the invention, the server-forming means are associated with means for registering that user in said server-forming means, such registration means being designated by general reference 5 in FIG. 1.

These registration means then for example allow an operator of the bank server-forming means to enter therein, information relative to a user to be registered, and for example in particular a telephone number at which the user can be reached.

In response to the registration of that user in the bank server-forming means, the latter send the user a connection code, for example such as an identifier.

This identifier is next used by the user when he wishes to connect to the bank server-forming means.

This identifier is thus for example introduced into the server-forming means by the user via the computer 2, when he wishes to access the server-forming means and more particularly the services, operations or accounts, etc., provided or managed by them.

Of course, other embodiments may be considered, the user also being able to use a telephone, such as a mobile telephone 4, to introduce that identifier.

After this step for the user to introduce his identification data, a step is provided for providing a voice connection between the user and the server-forming means.

To that end, the server-forming means call the user at the telephone number preregistered and pre-entered in the server-forming means during user registration, for example by the operator.

These server-forming means then for example call the user's mobile telephone, designated by general reference 4, which allows the user to establish a voice relationship and authenticate himself by voice with the server-forming means.

Several methods of authenticating the user may then be considered.

Thus, for example, the user's voice print may be determined from one or more sentences spoken by him, to perform that authentication. As an example, a sentence such as: “Hello. First name, last name. I am authenticating by voice”, may be used, as will be described in detail below.

According to another embodiment, the user may also for example dictate one or more pre-established messages, the server-forming means then carrying out an acquisition step for those dictated messages and a step for comparing those acquired messages to messages prerecorded in the server-forming means by the user, in order to authenticate, or not authenticate, that user, as illustrated in FIG. 1.

The means for acquiring messages dictated by the user are designated by general reference 6 in this FIG. 1, and they are compared in 7 to messages that are prerecorded and stored in means designated by general reference 8, in order to authenticate, or not authenticate, the user and to allow access to the server-forming means, or not allow such access, to the user.

This authentication and secure access operation is for example also illustrated in FIGS. 2 and 3.

FIG. 2 in fact illustrates the connection of the user, the latter being invited to enter his identifier, such as his connection code, for example, in 9 and to validate it, to be called on his telephone by the server-forming means.

Once the voice relationship is established with the server-forming means, the user then dictates one or more messages or sentences to authenticate himself with the bank server-forming means, which, if it is the case, i.e., if the user is authenticated, as illustrated in FIG. 3, provides the user with access to different services, operations, accounts, etc. offered and/or managed by the bank server-forming means for the user.

One of the services offered by the server-forming means is for example a service to register one or more of the user's bank cards, as illustrated in FIG. 4.

When the user activates the service or triggers the performance of that operation, the user must then for example enter the card number into the server-forming means, in order to register the latter with the server-forming means, as illustrated in FIG. 5.

One can then see that this access control method and system make it possible to improve the access security to the bank server-forming means in general.

Indeed, the user must not only enter a connection code, but also authenticate himself by voice with the bank server-forming means before accessing the different operations, services or accounts provided or managed by said server-forming means.

Thus, for example, one of these services or one of these operations may be a service for the dynamic generation of a cryptogram for securing a payment with the aid of the bank card, which has for example been registered as previously described with the server-forming means by the user.

This is for example illustrated in FIGS. 6 to 9.

FIG. 6 illustrates the activation of the service at the initiative of the user, for example by selecting that service from a list of services, operations, accounts or others offered to the user.

As illustrated in FIG. 7, the user next selects the bank card that he will use to make any payment, for example on a merchant or other site.

This bank card is for example selected by using and entering its number.

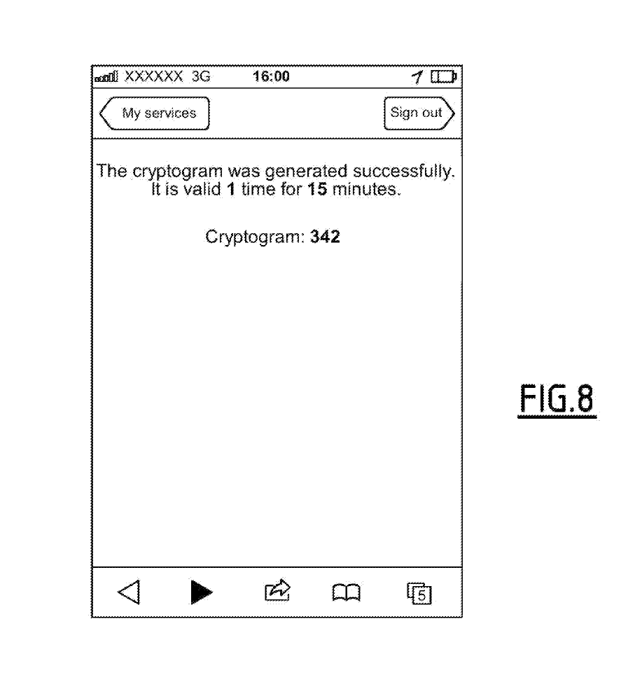

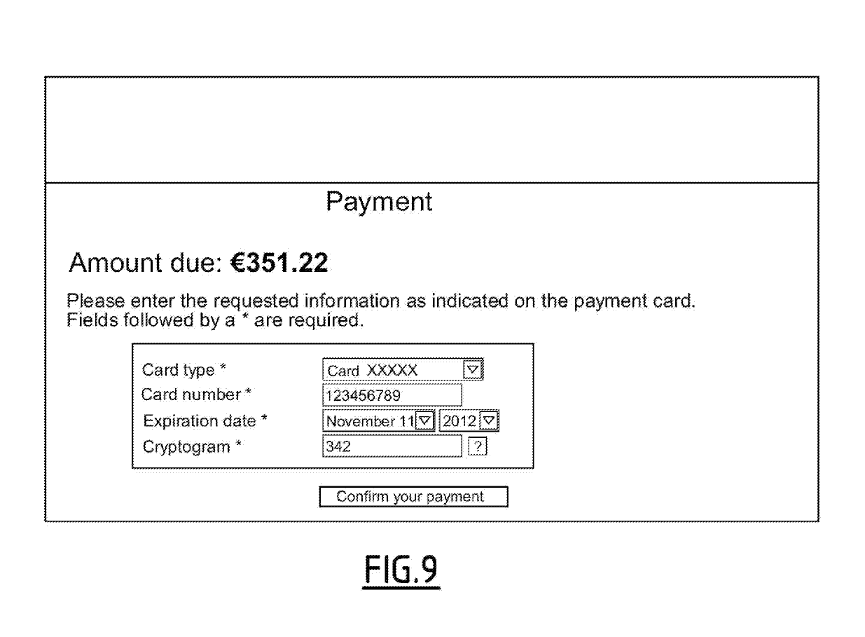

Once the bank card is selected, it is then possible for the server-forming means to launch the dynamic generation of a cryptogram for securing a payment using that bank card, as illustrated in FIGS. 8 and 9.

The cryptogram is then displayed to the user (FIG. 8), who can thus enter it to validate and secure a payment (FIG. 9).

This makes it possible to prevent the cryptogram from being taken and displayed permanently by the card, with the corresponding security problems.

In fact, the cryptogram for securing the payment by bank card is typically printed on the back of the bank card, which makes it easy to access and constitutes a security weakness.

In the system according to the invention, the cryptogram is generated dynamically, at the user's request, and is therefore not permanently printed on the card.

This cryptogram can then have predetermined validity attributes.

Thus, for example in FIG. 8, one can see that this cryptogram is associated with a message indicating the validity attributes of the cryptogram generated for the user, the latter for example being valid once for fifteen minutes to make a payment using the card.

One can thus see that this dynamic generation of a security cryptogram makes it possible to improve the usage security of bank cards.

Another service offered by the server-forming means is for example a service for activating one or more bank cards, as illustrated in FIGS. 10, 11 and 12.

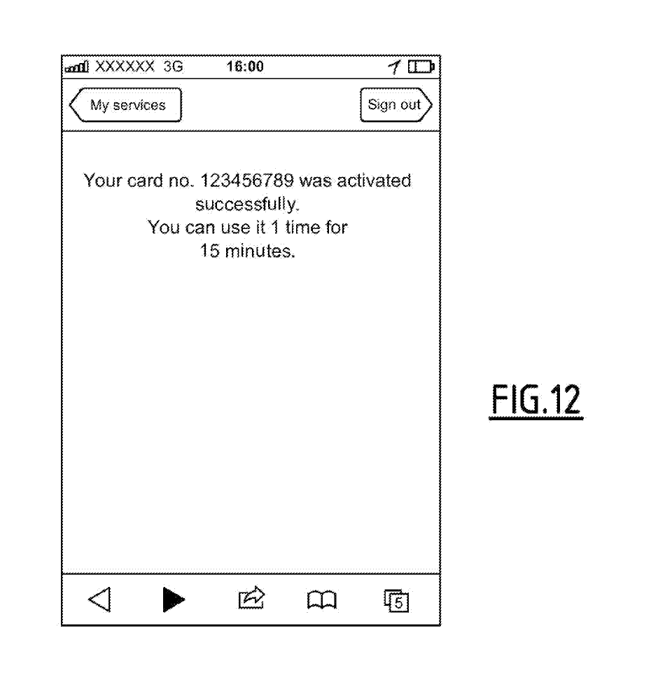

When the user activates the service or initiates the performance of this operation as illustrated in FIG. 10, it is then appropriate for example to enter the number of the card to be activated into the server-forming means, as illustrated in FIG. 11, in order to activate said card as illustrated in FIG. 12.

The card may in fact be deactivated by default and only be activated at the user's request or by someone acting on that user's behalf, for example a legal representative or other individual.

This also makes it possible to improve the usage security of these cards.

Activation attributes may of course be associated therewith, for example a number of possible uses and/or a maximum authorized amount and/or a usage time limited and/or geographical usage area, etc.

Thus, for example in FIG. 12, it is indicated that the card has been activated successfully and that it can be used once for fifteen minutes. Of course, this is only one example, and other attributes may be considered.

1-10. (canceled)

11. A method for securing a payment carried out with the aid of a payment card associated with card identification data and a security cryptogram, wherein the method includes an access step for accessing bank server-forming means forming a bank server for the dynamic generation of the security cryptogram for securing the payment.

12. The method according to claim 1, wherein the method includes an access step for accessing the bank server-forming means to activate the card.

13. The method according to claim 1, wherein the generation/activation is triggered at the user's initiative.

14. The method according to claim 1, wherein the access step includes:
a step for the insertion of identification data by the user,
a step for creating a voice connection between the user and the server-forming means, and
a voice authentication step for voice authentication of the user to validate, or not validate, access to the server-forming means, by the latter.

15. The method according to claim 4, wherein the step for insertion by the user of identification data comprises a step for the introduction by the latter of a connection code.

16. The method according to claim 5, wherein the connection code has been provided to the user by the server-forming means, during the registration of that user in the server-forming means.

17. The method according to claim 4, wherein the step for creating a voice connection between the user and the server-forming means includes a step for calling the identified user at a preregistered telephone number.

18. The method according to claim 4, wherein the voice authentication step includes determining the user's voice print in order to authenticate, or not authenticate, that user.

19. The method according to claim 4, wherein the voice authentication step includes the acquisition, by the server-forming means, of pre-established messages dictated by the user and comparing those acquired messages to messages pre-recorded in the server-forming means by the user, to authenticate, or not authenticate, that user.

20. A system for securing a payment carried out with the aid of a payment card associated with card identification data and a security cryptogram for implementing a method according claim 1, wherein the system includes accessing means for accessing bank server-forming means for the dynamic generation of the security cryptogram for securing the payment.
